(19) United States
(12) Patent Application Publication
(10) Pub. No.: US 2011/0179497 A1
(43) Pub. Date: Jul. 21, 2011

(54) DATA TRANSMISSION AND RECEPTION CONTROL APPARATUS, AND DATA TRANSMISSION AND RECEPTION SYSTEM, METHOD, AND PROGRAM

(76) Inventors: Yasushi Ayaki, Osaka (JP); Kazunari Fujiwara, Osaka (JP); Takuya Nishimura, Osaka (JP)

(21) Appl. No.: 13/121,252

(22) PCT Filed: Sep. 28, 2009
(86) PCT No.: PCT/JP2009/004909

§ 371 Date: Mar. 28, 2011

(30) Foreign Application Priority Data
Sep. 29, 2008 (JP) 2008-251743

(51) Int. Cl. H04L 9/32

(52) U.S. Cl. 726/26

(57) ABSTRACT

A portable terminal (2) is a data transmission and reception control apparatus. A Proximity confirmation unit (23) confirms a first proximity condition of proximity to the data transmission apparatus. A proximity apparatus authentication and registration processing unit (21) registers the portable terminal (2) into the data transmission apparatus when authentication in conjunction with the data transmission apparatus is successful, and the first proximity condition is satisfied. A proximity confirmation unit (27) confirms a second proximity condition of proximity to the data reception apparatus. A registration starting and authentication processing unit (26) obtains identification information of the data reception apparatus when authentication in conjunction with the data reception apparatus is successful, and when the second proximity condition is satisfied. An authentication and registration processing unit (22) registers the identification information of the data reception apparatus into the data transmission apparatus when authentication in conjunction with the data transmission apparatus is successful.

### TECHNICAL FIELD

The present invention relates to a data transmission and reception control apparatus, a data transmission and reception system, a method, and a program for transmitting copyright protected AV data.

### BACKGROUND ART

Recent years have seen the gradual implementation of a home area AV (Audio Visual) network in which AV apparatuses installed in the home is connected by a network to share various AV contents.

The home area AV network can be implemented for example by providing a router inside the house, and connecting various apparatuses such as PC and digital television and an AV server which stores content to the router in a star topology. The router is for connecting a network established within the home and a network established out-of-home.

The AV server in the home stores once various contents acquired from the out-of-home network through the router, as well as various AV contents acquired other than from the out-of-home network, such as a program of digital broadcasting, and then transmits the stored various AV contents to the reception apparatus such as a television, as requested by various apparatuses.

On the other hand, when dealing with an AV content which is subject to copyright protection, a copyright of the AV content needs to be protected when the AV content is transmitted via the network. In general, the copyright is protected through encryption of data subject to copyright protection such that an illegal use of the data is prevented.

Such copy right protection system is standardized for example as a Digital Transmission Content Protection over Internet Protocol (DTCP-IP) method.

The DTCP-IP method includes an authentication function as well as an invalidation function of a key. When transmitting the AV data, illegal apparatuses are eliminated and the AV data subject to copyright protection are transmitted after the encryption. Thus the copyright of the AV data is protected.

Furthermore, recording, reproduction or other use of AV content such as digital broadcasting program is usually allowed only for personal use within a home, and thus the use beyond the personal use also needs to be restricted. For example, distribution of the AV data stored in the AV server installed in a home of a user to unspecified large number of out-of-home reception apparatuses via the Internet needs to be restricted.

In the DTCP-IP method, Time To Live (TTL) and Round Trip Time (RTT) are used in order to limit a range which a command to be transmitted can reach. Here, TTL corresponds to a number of the routers to be relayed, and the maximum number of routers that an IP packet can go through can be designated by a value set in a TTL field included in an IP packet header. DTCP-IP specifies to set the TTL of the IP packet which transmits a command for exchanging an authentication key to three or less.

Also, in an authentication processing according to the DTCP-IP, a command transaction for measuring the RTT is specified. A transmission apparatus which transmits the AV data transmits the command for measuring the RTT to a reception apparatus, and measure the RTT by measuring the time taken before receiving a response from the reception apparatus. A key exchange processing is performed only when the RTT is 7 ms or less.

As described, in DTCP-IP method, it is determined that the transmission apparatus and the reception apparatus are closely located on a network by confirming that the TTL value and RTT value are within the predetermined respective threshold values to prevent the unrestricted distribution of AV data to an out-of-home apparatus. It is to be noted that determining whether the reception apparatus is closely located to the transmission apparatus on a network is hereinafter referred to as confirmation of proximity, or proximity confirmation in short.

The technical problem of the proximity confirmation lies in that the use of data which is within a realm of personal use is also restricted. In specific, the user of the AV server cannot watch the AV content recorded in the AV server installed in the home of the user from out-of-home personally. In view of this, a data transmission and reception system that allows the user out-of-home to personally use the AV data while preventing the unrestricted AV data distribution to the out-of-home apparatus has been proposed (for example, see Patent Literature (PTL) 1).

Following describes operations of an aforementioned conventional data transmission and reception system.

FIG. 12 is a diagram showing the conventional data transmission and reception system. A data transmission apparatuses installed inside the home and out-of-home, data reception apparatus, and a bridge apparatus are connected via a home network and an Internet.

As shown in FIG. 12, an AV server 101 and a digital television 102 are installed in the home, and are connected via a home network 103. The home network 103 includes a wireless media (IEEE 802.11), wired media (IEEE 802.3) or the like.

A home boundary bridge 104 is the bridge apparatus for performing transmission and reception of the AV data between the apparatus installed in the home and the apparatus installed out-of-home. The home boundary bridge 104 is connected to the AV server 101 and the digital television 102, which are the apparatuses installed in the home, via the home network 103. The home boundary bridge 104 is also connected to a portable terminal 106 and a portable PC 107, which are the apparatuses installed out-of-home, via an Internet 105.

Furthermore, the aforementioned DTCP-IP method is implemented in the AV server 101, the digital television 102, and the home boundary bridge 104, which are installed in the home. When the AV data is transmitted between the apparatuses installed in the home, confirmation of proximity using the TTL and RTT is performed.

As mentioned earlier, when the home boundary bridge 104 transmits the AV data between the apparatuses installed in the home, the home boundary bridge 104 allows the confirmation of proximity and the authentication processing according to the DTCP-IP method to be performed. And when the home boundary bridge 104 transmits the AV data between the apparatus installed in the home and the apparatus installed out-of-home, the home boundary bridge 104 allows a special authentication processing, which does not involve the confirmation of proximity and is different from the DTCP-IP method, to be performed.

To perform transmission and reception of the AV data between the apparatus installed in the home and the portable terminal 106 through the home boundary bridge 104, the portable terminal 106 needs to be registered into the home boundary bridge 104 in advance.

FIG. 13 is a diagram showing operations and communication between the home boundary bridge 104 and the portable terminal 106 for registering the portable terminal 106, which is going to be used out-of-home, into the home boundary bridge 104.

First, the home boundary bridge 104 is set to a registration mode (S900). Then, the portable terminal 106 is connected to the home boundary bridge 104 via the home network 103 to transmit, to the home boundary bridge 104, a request for registering identification information of the portable terminal 106. The home boundary bridge 104 performs an authentication processing which involves proximity confirmation in conjunction with the portable terminal 106 (S902). The home boundary bridge 104 determines whether or not the portable terminal 106 has been successfully authenticated, and determines whether or not the number of the portable terminals registered in the home boundary bridge 104 is within a predetermined value (S903, S904). When it is YES in both steps S903 and S904, the home boundary bridge 104 registers the identification information of the portable terminal 106 (S905) into the home boundary bridge 104. When it is NO in either step S903 or step S904, the registration is not performed. When the registration processing is completed, the registration mode of the home boundary bridge 104 is canceled (S906) to end.

To access the apparatus installed in the home from out-of-home, the portable terminal 106 transmits to the home boundary bridge 104, the request for special authentication for the apparatus installed out-of-home so that the authentication processing which does not involve proximity confirmation is performed. When the portable terminal 106 is successfully authenticated and the identification information of the portable terminal 106 has been registered in the home boundary bridge 104 as the out-of-home apparatus, a key exchange processing is performed to share key information so that encrypted-data transmission can be performed. The key exchange processing is not performed when the portable terminal 106 fails to be authenticated or when the portable terminal 106 has not been registered in the home boundary bridge 104 as the out-of-home apparatus.

For example, referring to FIG. 12, the portable PC 107 which has not been registered in the home boundary bridge 104 transmits, to the home boundary bridge 104, the request for special authentication for the apparatus installed out-of-home, the home boundary bridge 104 does not perform the key exchange processing because the portable PC 107 is an unregistered apparatus.

As described above, in conventional data transmission system, the reception apparatus which is going to be used out-of-home is registered into the home boundary bridge apparatus prior to use. For the registration, the reception apparatus is connected, at home, to the home network for the authentication processing which involves proximity confirmation. The reception apparatus is registered into the home boundary bridge apparatus only when the reception apparatus is successfully authenticated. Thus, it is possible to distribute the AV data to out-of-home only when the AV data is received by a genuine reception apparatus. In addition, unrestricted distribution of the AV data to out-of-home is prevented by limiting the number of the reception apparatuses registered into the home boundary bridge apparatus.

### [Citation List]

### [Patent Literature]

### [PTL 1]

Japanese Unexamined Patent Application Publication No. 2004-180020 (Page 10).

### SUMMARY OF INVENTION

### Technical Problem

However, the data transmission and reception system having the aforementioned structure requires an AV apparatus which is going to be used to access, from out-of-home, the AV data stored at home to be brought into the home once prior to use. In the home, the AV apparatus is connected to the home network and registered into the home boundary bridge.

Therefore, when the user accesses the AV data stored at home using the stationary AV apparatus installed in a place other than the home of the user, the user has to bring the stationary AV apparatus into home once for registration and then deliver such stationary AV apparatus to the place other than the home of the user. This is rather inconvenient. In addition, there is an inconveniency of not being able to access the AV data stored at home using the stationary AV apparatus installed in accommodation facilities or other locations.

The present invention is conceived in view of the above described situation, and its object is to increase a convenience in using: the data transmission control apparatus which distributes the AV data stored at home to the genuine out-of-home AV apparatus; a data reception apparatus; and the data transmission and reception system. In particular, the present invention aims at providing a technology for enabling the distribution of the AV data stored at home to the AV apparatus used out-of-home without bringing such AV apparatus into the home prior to use.

### Solution to Problem

In order to achieve the object described above, a data transmission and reception control apparatus according to the present includes the following. A first proximity confirmation unit configured to confirm whether or not a first proximity condition is satisfied. The first proximity condition relates to a distance on a network between a data transmission apparatus which transmits AV data to a pre-registered apparatus and the data transmission and reception control apparatus. A proximity apparatus authentication and registration processing unit configured to perform authentication in conjunction with the data transmission apparatus, and, when the authentication is successful and when it is confirmed that the first proximity condition is satisfied, to register first identification information into the data transmission apparatus. The first identification information is identification information of the data transmission and reception control apparatus. A second proximity confirmation unit configured to confirm whether or not a second proximity condition is satisfied. The second proximity condition relates to a distance on a network between a data reception apparatus which is capable of receiving the AV data and the data transmission and reception control apparatus. A registration starting and authentication processing unit configured to perform authentication in conjunction with the data reception apparatus, and, when the authentication is successful and when it is confirmed that the second proximity condition is satisfied, to obtain second identification information. The second identification information is the identification information of the data reception apparatus. An authentication and registration processing unit configured to perform authentication in conjunction with the data transmission apparatus, and, when the authentication is successful, to register the obtained second identification information into the data transmission apparatus.

A data transmission and reception system according to the present information includes a data transmission apparatus which transmits AV data to a pre-registered apparatus, a data reception apparatus which is capable of receiving the AV data, and the data transmission and reception control apparatus described above. The data transmission apparatus transmits, to the data reception apparatus, the AV data according to the registration of the identification information of the data reception apparatus into the data transmission apparatus by the data transmission and reception control apparatus.

In addition, the present invention can be realized not only as the data transmission and reception control apparatus and the data transmission and reception system, but can also be realized as a data transmission and reception control method and a computer program.

### ADVANTAGEOUS EFFECTS OF INVENTION

As described above, a portable data transmission and reception control apparatus of the present invention is used to confirm the proximity to the data transmission apparatus and the proximity to the data reception apparatus, and then register the data reception apparatus into the data transmission apparatus. Thus, the present invention allows the data reception apparatus installed in a remote area from the home of the user to be registered into the data transmission apparatus installed in the home of the user without bringing the data reception apparatus into the home of the user. In addition, the present invention prevents the unrestricted distribution of data to the out-of-home apparatus.

### BRIEF DESCRIPTION OF DRAWINGS

[FIG. 1]

FIG. 1 is a diagram showing a structure of a data transmission and reception system according to Embodiment 1 of the present invention.

[FIG. 2]

FIG. 2 is a diagram showing a structure of an authentication and registration processing unit in a data transmission and reception control apparatus according to Embodiment 1 of the present invention.

[FIG. 3]

FIG. 3 is a diagram showing a structure of an encryption and transmission unit in a data transmission apparatus according to Embodiment 1 of the present invention.

[FIG. 4]

FIG. 4 is a diagram showing a structure of a reception and decryption unit in a data reception apparatus according to Embodiment 1 of the present invention.

[FIG. 5]

FIG. 5 is a diagram showing a sequence of a proximity apparatus registration processing according to Embodiment 1 of the present invention.

[FIG. 6]

FIG. 6 is a diagram showing a sequence of a registration processing according to Embodiment 1 of the present invention.

[FIG. 7]

FIG. 7 is a diagram showing a sequence of an encrypted-data transmission processing according to Embodiment 1 of the present invention.

[FIG. 8]

FIG. 8 is a diagram showing a structure of a data transmission and reception system according to Embodiment 2 of the present invention.

[FIG. 9]

FIG. 9 is a diagram showing a structure of an authentication and registration processing unit in a data transmission and reception control apparatus according to Embodiment 2 of the present invention.

[FIG. 10]

FIG. 10 is a diagram showing a structure of a reception and decryption unit in a data reception apparatus according to Embodiment 2 of the present invention.

[FIG. 11]

FIG. 11 is a diagram showing a sequence of a registration processing according to Embodiment 2 of the present invention.

[FIG. 12]

FIG. 12 is a diagram showing a structure of a conventional data transmission and reception system.

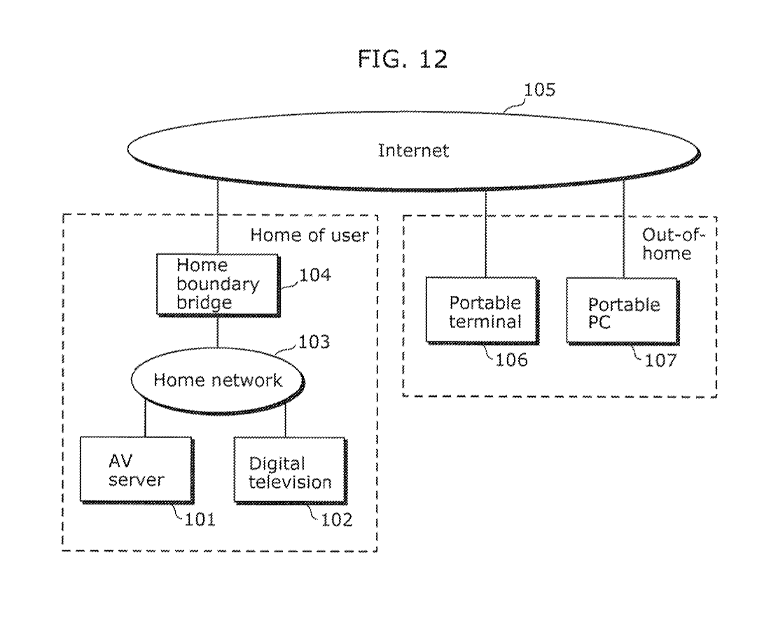

[FIG. 13]

FIG. 13 is a diagram showing a sequence of a registration processing according to a conventional data transmission and reception system.

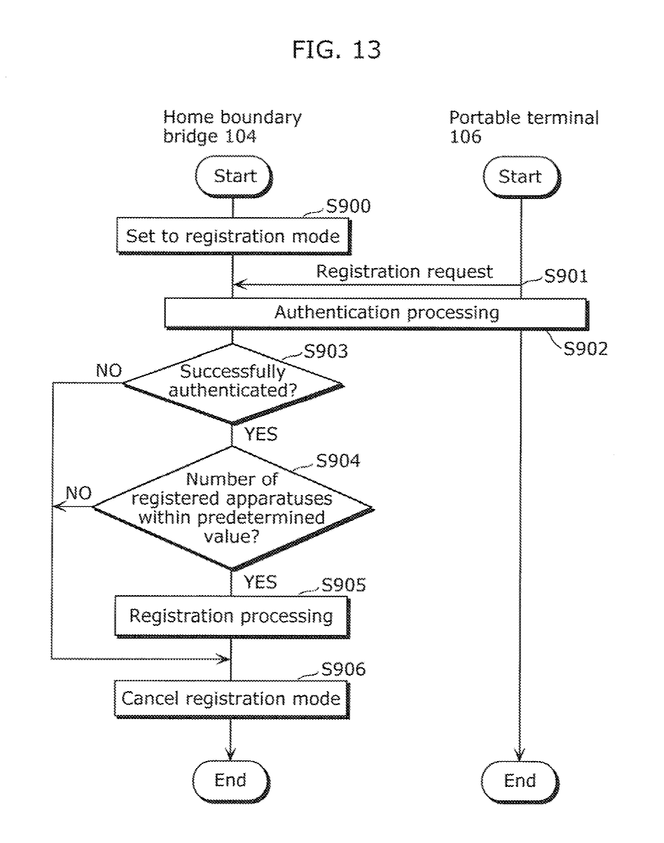

### DESCRIPTION OF EMBODIMENTS

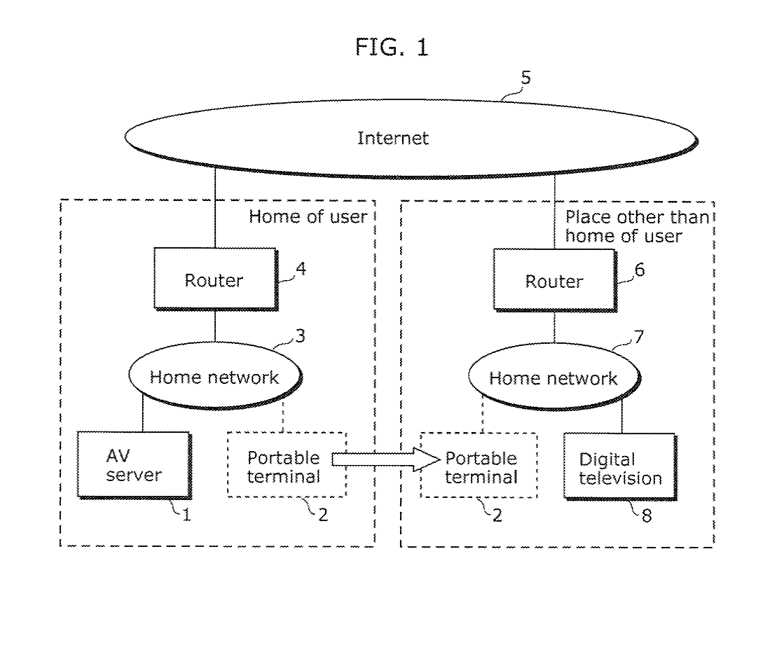

Embodiments of the present invention will be described in detail with reference to FIG. 1 to FIG. 11.

### Embodiment 1

FIG. 1 is a diagram showing a data transmission and reception system according to this Embodiment. A data transmission apparatus, a data reception apparatus, a data transmission and reception control apparatus, and a router are connected via a home network and the Internet.

As shown in FIG. 1, an AV server 1, which is the data transmission apparatus, and a router 4 are connected via a home network 3 in a home of a user.

The router 4 is also connected via an Internet 5 to a router 6 installed in a place other than the home of the user. The router 6 is connected via a home network 7 to a digital television 8, which is the data reception apparatus.

A portable terminal 2, which is the data transmission and reception control apparatus, is an apparatus which is carried around and used by the user. When the user is at home, the portable terminal 2 is connected to the home network 3 established in the home of the user to communicate with the apparatus installed in the home. When the user is in the place other than the home of the user, the portable terminal 2 is connected to the home network 7 to communicate with the apparatus installed in the place other than the home of the user.

<A Structure of the Data Transmission and Reception Control Apparatus>

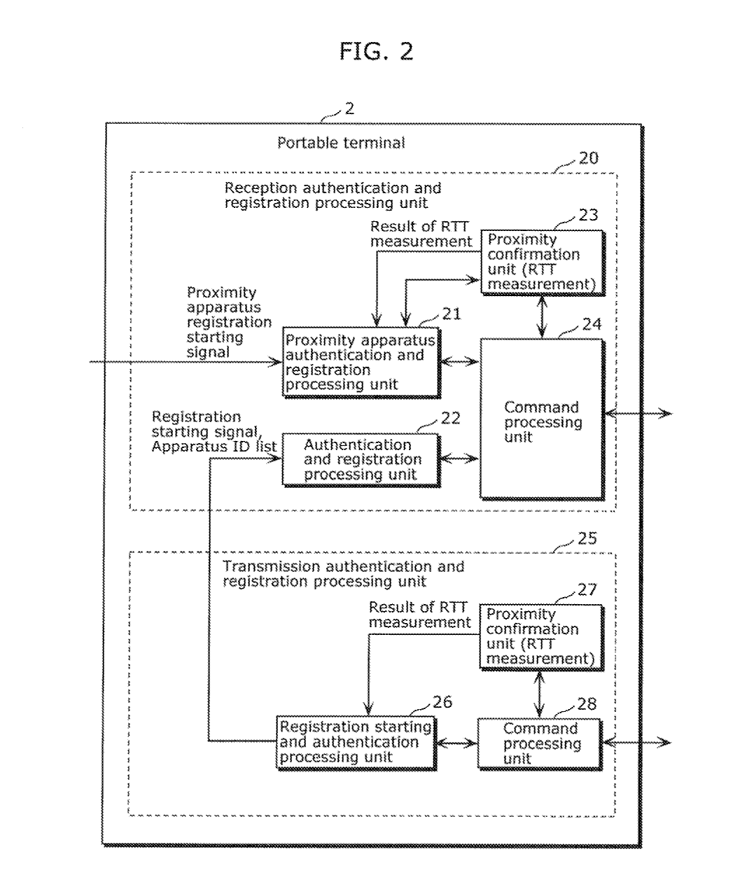

FIG. 2 is a block diagram showing a structure of an authentication and registration processing unit in the portable terminal 2, which is the data transmission and reception control apparatus.

The authentication and registration processing unit in the portable terminal 2 includes: a reception authentication and registration processing unit 20 which performs the authentication and registration processing as the data reception apparatus for the data transmission apparatus (for example, the AV server 1 in FIG. 1); and an transmission authentication and registration processing unit 25 which performs the authentication and registration processing as the data transmission apparatus for the data reception apparatus (for example, the digital television 8 in FIG. 1).

The reception authentication and registration processing unit 20 includes: a proximity apparatus authentication and registration processing unit 21, an authentication and registration processing unit 22, a proximity confirmation unit 23, and a command processing unit 24. The transmission authentication and registration processing unit 25 includes: a registration starting and authentication processing unit 26; a proximity confirmation unit 27; and a command processing unit 28.

When receiving a proximity apparatus registration starting signal with the operation of the portable terminal 2 by the user, the proximity apparatus authentication and registration processing unit 21 in the reception authentication and registration processing unit 20 performs the following in conjunction with the data transmission apparatus by controlling the proximity confirmation unit 23 and the command processing unit 24: a proximity apparatus registration and authentication processing in which an apparatus ID of the data transmission and reception control apparatus is registered into the data transmission apparatus after performing a mutual authentication; and an RTT measurement processing in which the proximity is confirmed.

When receiving the registration starting signal and the apparatus ID from the registration starting and authentication processing unit 26, the authentication and registration processing unit 22 performs, by controlling the command processing unit 24, the authentication and registration processing in which an apparatus ID of the data reception apparatus that is obtained from the data reception apparatus is registered into the data transmission apparatus.

The proximity confirmation unit 23 performs, by controlling the command processing unit 24, the RTT measurement processing in conjunction with the data transmission apparatus and then outputs to the proximity apparatus authentication and registration processing unit 21 the result of the RTT measurement.

Under the control of the proximity apparatus authentication and registration processing unit 21, the authentication and registration processing unit 22, and the proximity confirmation unit 23, the command processing unit 24 performs the transmission and reception of various commands between the command processing unit 24 and the data transmission apparatus.

The registration starting and authentication processing unit 26 in the transmission authentication and registration processing unit 25, using the command processing unit 28, performs the registration starting and authentication processing in which the apparatus ID is obtained from the data reception apparatus after performing the mutual authentication in conjunction with the data reception apparatus, and then outputs to the authentication and registration processing unit 22 the registration starting signal and the obtained apparatus ID depending on the result of the RTT measurement received from the proximity confirmation unit 27.

The proximity confirmation unit 27 performs, by controlling the command processing unit 28, the RTT measurement processing to measure the RTT to the data reception apparatus, and confirms the proximity by comparing the measured RTT with a predetermined value (in this Embodiment, 1 ms), and then outputs, to the registration starting and authentication processing unit 26, the confirmed proximity as the result of the RTT measurement. The proximity confirmation unit 27 also transmits, to the data reception apparatus, the result of the RTT measurement using the command processing unit 28.

Under the control of the registration starting and authentication processing unit 26 and the proximity confirmation unit 27, the command processing unit 28 performs the transmission and reception of various commands between the command processing unit 28 and the data reception apparatus.

<A structure of the Data Transmission Apparatus>

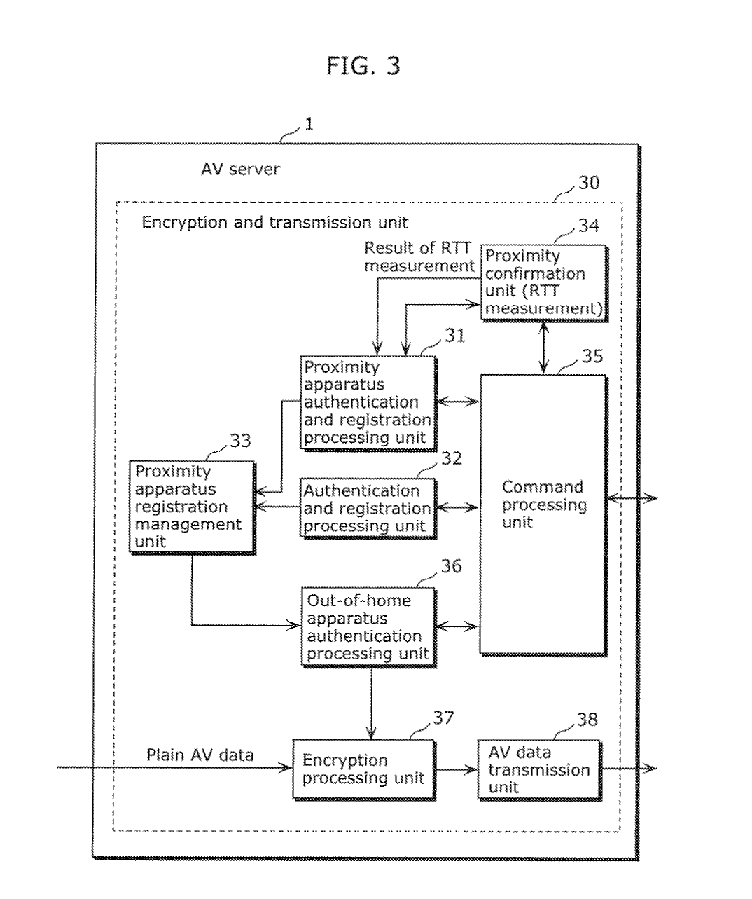

FIG. 3 is a block diagram showing the structure of an encryption and transmission unit in the AV server 1, which is the data transmission apparatus.

An encryption and transmission unit 30 in the AV server 1 includes: a proximity apparatus authentication and registration processing unit 31, a authentication and registration processing unit 32, a proximity apparatus registration management unit 33, a proximity confirmation unit 34, a command processing unit 35, an out-of-home apparatus authentication processing unit 36, an encryption processing unit 37, and an AV data transmission unit 38.

The proximity apparatus authentication and registration processing unit 31 performs, using the command processing unit 35, the proximity apparatus authentication and registration processing in which an apparatus ID of the portable terminal 2 is obtained after performing the mutual authentication in conjunction with the portable terminal 2, and then outputs, to the proximity apparatus registration management unit 33, the apparatus ID of the portable terminal 2 depending on the result of the RTT measurement received from the proximity confirmation unit 34.

The authentication and registration processing unit 32, using the command processing unit 35, performs the authentication and registration processing in which the apparatus ID of the data reception apparatus which has been obtained by the portable terminal 2 is received from the portable terminal 2 after performing only the mutual authentication, without proximity confirmation, in conjunction with the portable terminal 2, and then outputs to the proximity apparatus registration management unit 33 the apparatus ID of the data reception apparatus received through the portable terminal 2.

The proximity apparatus registration management unit 33 registers and manages the apparatus ID of the data reception apparatus received from the proximity apparatus authentication and registration processing unit 31 and the authentication and registration processing unit 32, and then outputs the registered and managed apparatus ID to the out-of-home apparatus authentication processing unit 36 as a registered apparatus ID list.

The proximity confirmation unit 34 performs, by controlling the command processing unit 35, RTT measurement processing in conjunction with the portable terminal 2, and then outputs the result of the RTT measurement to the proximity apparatus authentication and registration processing unit 31.

Under the control of the proximity apparatus authentication and registration processing unit 31, the authentication and registration processing unit 32, the proximity confirmation unit 34, and the out-of-home apparatus authentication processing unit 36, the command processing unit 35 performs the transmission and reception of various commands either between the command processing unit 35 and the portable terminal 2 or between the command processing unit 35 and the data reception apparatus via the home network 3.

The out-of-home apparatus authentication processing unit 36, when the apparatus ID of the data reception apparatus is included in the registered apparatus ID list received from the proximity apparatus registration management unit 33, performs the following in conjunction with the data reception apparatus using the command processing unit 35: the out-of-home apparatus authentication processing in which only the mutual authentication, without proximity confirmation, is performed; a key exchange processing in which an encryption key and a decryption key are exchanged. Then, using the command processing unit 35, the out-of-home apparatus authentication processing unit 36 outputs the exchanged encryption key to the encryption processing unit 37.

The encryption processing unit 37 encrypts plain AV data using the encryption key received from the out-of-home apparatus authentication processing unit 36, and then outputs the encrypted AV data to the AV data transmission unit 38.

The AV data transmission unit 38 receives the encrypted AV data from the encryption processing unit 37, and outputs the received encrypted AV data to an other apparatus via the home network 3.

<A Structure of the Data Reception Apparatus>

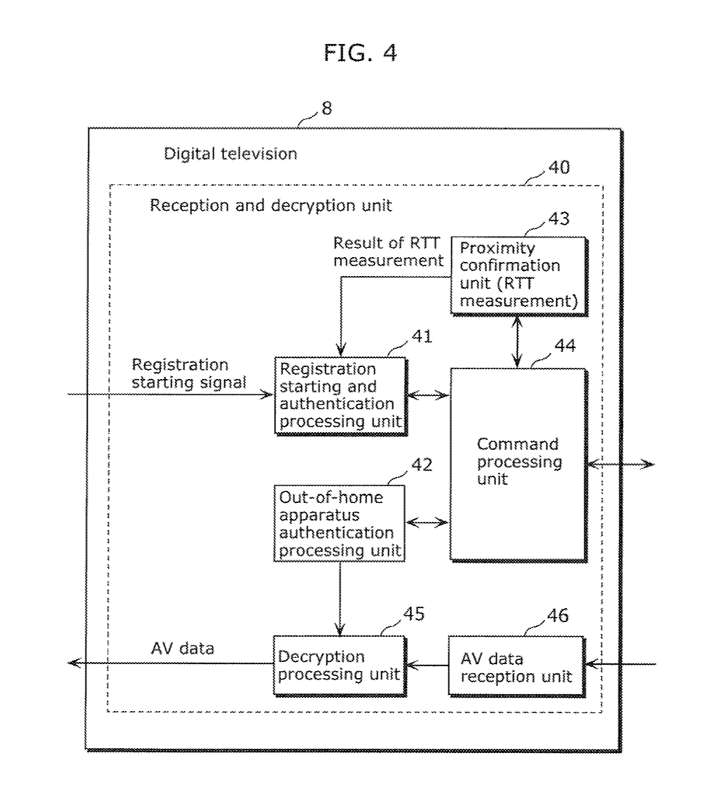

FIG. 4 is a block diagram showing a structure of a reception and decryption unit 40 in a digital television 8, which is the data reception apparatus.

The reception and decryption unit 40 in the digital television 8 includes: the registration starting and authentication processing unit 41, the out-of-home apparatus authentication processing unit 42, the proximity confirmation unit 43, the command processing unit 44, the decryption processing unit 45, and the AV data reception unit 46.

The registration starting and authentication processing unit 41, using the command processing unit 44, performs the registration starting and authentication processing in which the apparatus ID of the digital television 8 is transmitted to the portable terminal 2 after performing the mutual authentication in conjunction with the portable terminal 2, and then outputs to the portable terminal 2 the apparatus ID of itself, the registration starting and authentication processing unit 41, depending on the result of the RTT measurement received from the proximity confirmation unit 43.

The out-of-home apparatus authentication processing unit 42, using the command processing unit 44, performs the following in conjunction with the AV server 1, which is the data transmission apparatus: the out-of-home apparatus authentication processing in which only the mutual authentication, without proximity confirmation, is performed; and the key exchange processing in which the encryption key and the decryption key are exchanged, and then outputs to the decryption processing unit 45 the exchanged decryption key.

The proximity confirmation unit 43, using the command processing unit 44, performs the RTT measurement processing in conjunction with the portable terminal 2, and then outputs to the registration starting and authentication processing unit 41 the result of the RTT measurement.

Under the control of the registration starting and authentication processing unit 41, the proximity confirmation unit 43, and the out-of-home apparatus authentication processing unit 42, the command processing unit 44 performs the transmission and reception of various commands either between the command processing unit 44 and the portable terminal 2 or between the command processing unit 44 and the data transmission apparatus via the home network 7.

The decryption processing unit 45 decrypts the encrypted AV data received from the AV data reception unit 46 using the decryption key received from the out-of-home apparatus authentication processing unit 42, and then outputs the decrypted AV data.

The AV data reception unit 46 outputs, to the decryption processing unit 45, the encrypted AV data received via the home network 7.

Following describes a sequence of each processing performed by the data transmission and reception system having the above structure.

<A sequence of Proximity Apparatus Registration Processing>

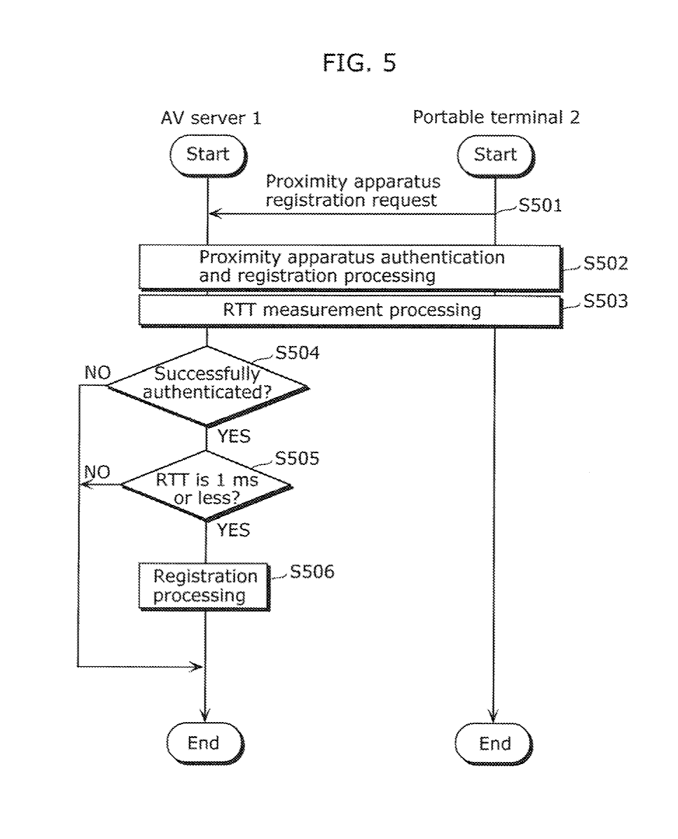

FIG. 5 is a diagram showing a processing sequence of the proximity apparatus registration processing in which, in the home of the user, the portable terminal 2, which is the data transmission and reception control apparatus, is registered into the AV server 1, which is the data output apparatus, as the apparatus which has permission to access the AV server 1 from out-of-home. The aforementioned proximity apparatus authentication and registration processing is included in this proximity apparatus registration processing.

As the data reception apparatus, the portable terminal 2 transmits to the AV server 1, which is the data transmission apparatus, the proximity apparatus registration request (S501), and performs the proximity apparatus authentication and registration processing S502, and subsequently performs the RTT measurement processing S503. The AV server 1 determines in the determination processing S504 whether or not the portable terminal 2 has been successfully authenticated, and confirms in the determination processing S505 whether or not the RTT is 1 ms or less in order to confirm the proximity. When it is YES in both S504 and S505, the AV server 1 registers the apparatus ID of the portable terminal 2 into the AV server 1 as the apparatus which has permission to access the AV server 1 from out-of-home (S506).

<A Sequence of Registration Processing>

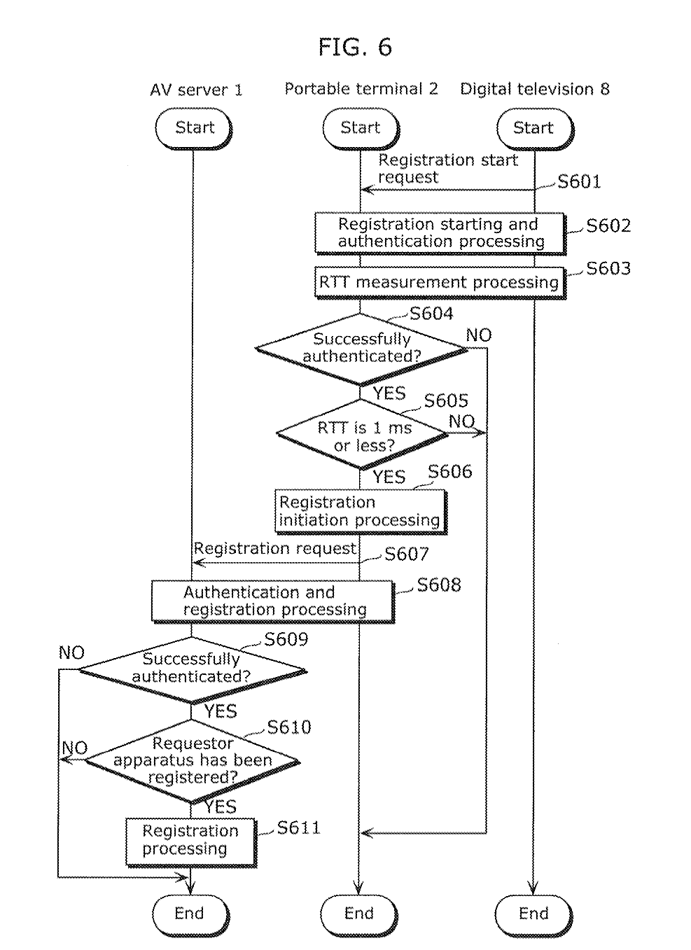

FIG. 6 is a diagram showing a processing sequence of the registration processing in which an apparatus ID of the digital television 8, which is the data reception apparatus installed in a place other than the home of the user, is registered into the AV server 1, which is the data output apparatus installed in the home of the user, as the apparatus which has permission to access the AV server 1 from out-of-home, using the portable terminal 2, which is the data transmission and reception control apparatus. The aforementioned registration starting and authentication processing and the authentication and registration processing are included in this registration processing.

After the proximity apparatus registration processing described above has been completed, the portable terminal 2, in the place other than the home of the user, receives the registration start request along with the apparatus ID of the digital television 8 from the digital television 8, which is the data reception apparatus (S601), and performs the registration starting and authentication processing S602 and subsequently the RTT measurement processing S603. The portable terminal 2 determines in the determination processing S604 whether or not the digital television 8 has been successfully authenticated, and confirms in the determination processing S605 whether or not the RTT is 1 ms or less in order, to confirm the proximity. When it is YES in both S604 and S605, the portable terminal 2 performs a registration initiation processing (S606) to proceed the registration processing.

In the registration initiation processing, the portable terminal 2 transmits, via the Internet 5, the registration request along with the apparatus

ID of the digital television 8 and the apparatus ID of itself, the portable terminal 2 as a requestor of the registration, to the AV server 1, which is installed in the home of the user (S607). Then, the portable terminal 2 performs the authentication and registration processing S608 which does not involve the RTT measurement. The AV server 1 determines in the determination processing S609 whether or not the digital television 8 has been successfully authenticated, and confirms in the determination processing S610 whether or not the apparatus ID of the portable terminal 2, the requestor of the registration, has been registered in the proximity apparatus registration management unit 33. When it is YES in both steps S609 and S610, the AV server 1 registers the apparatus ID of the digital television 8 which is received from the portable terminal 2 into the proximity apparatus registration management unit 33 as the apparatus which has permission to access the AV server 1 from out-of-home (S611).

<A Sequence of an Encrypted-Data Transmission Processing>

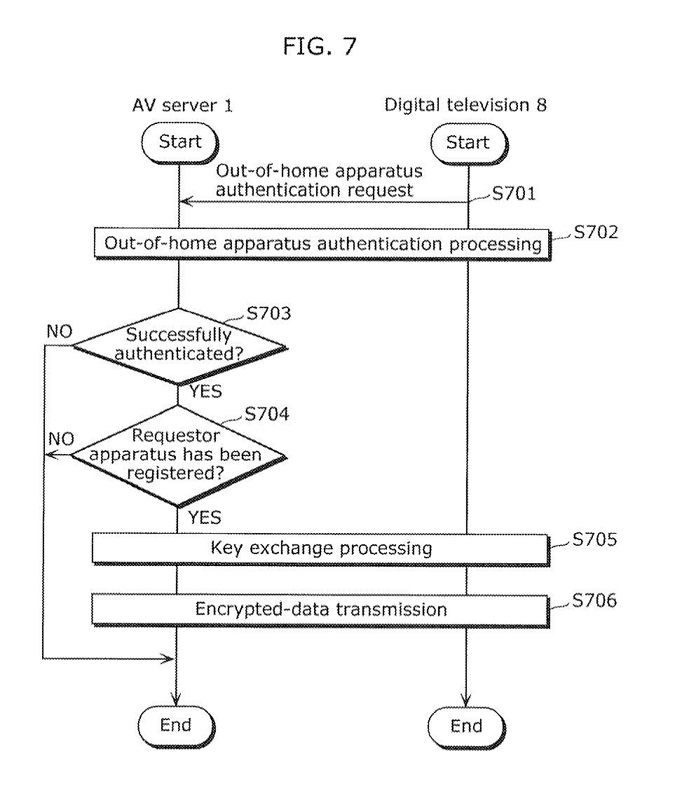

FIG. 7 is a diagram showing the processing sequence of an encrypted-data transmission processing in which the digital television 8, which is the data reception apparatus installed in the place other than the home of the user, accesses the AV server 1, which is the data output apparatus installed in the home of the user, via the Internet 5 and receives the AV data from the AV server 1 via the Internet 5. The aforementioned out-of-home apparatus authentication processing is included in this encrypted-data transmission processing.

The digital television 8 installed in the place other than the home of the user transmits the request for the out-of-home apparatus authentication along with the apparatus ID of the digital television 8 to the AV server 1 installed in the home of the user via the Internet 5 (S701) performs the out-of-home apparatus authentication processing S702 that does not involve the RTT measurement. The AV server 1 determines in the determination processing S703 whether or not the digital television 8 has been successfully authenticated, and confirms in the determination processing S704 whether or not the apparatus ID of the digital television 8, the requestor of the authentication, has been registered in the proximity apparatus registration management unit 33. When it is YES in both S703 and S704, the AV server 1 performs the key exchange processing S705 with the digital television 8 to share the exchange key, and then performs the encrypted-data transmission S706.

With the data transmission and reception system according to this Embodiment, the processing described above allows the identification information of the data reception apparatus installed in a place other than the home of the user to be registered into the data transmission apparatus installed in the home of the user, without moving the data reception apparatus. As a result, the user can access the data transmission apparatus installed in the home of the user via the Internet from out-of-home, and receive the AV data. On the other hand, the data transmission and reception system according to this Embodiment requires the user to use the same portable data transmission and reception control apparatus to confirm the proximity to the data transmission apparatus and the proximity to the data reception apparatus, and then perform the registration processing. As a result, it is possible to prevent the unrestricted distribution of AV data stored in the data transmission apparatus installed in the home to the out-of-home data reception apparatus.

Furthermore, in the place other than the home of the user, after the data transmission and reception control apparatus according to this embodiment confirms the proximity to the data reception apparatus, and obtains the apparatus ID of the data reception apparatus, the data transmission and reception control apparatus according to this embodiment initiates and performs the registration processing on the spot. The apparatus ID of the data reception apparatus installed in the place other than the home of the user can be registered into the data transmission apparatus installed in the home of the user without interruption.

### Embodiment 2

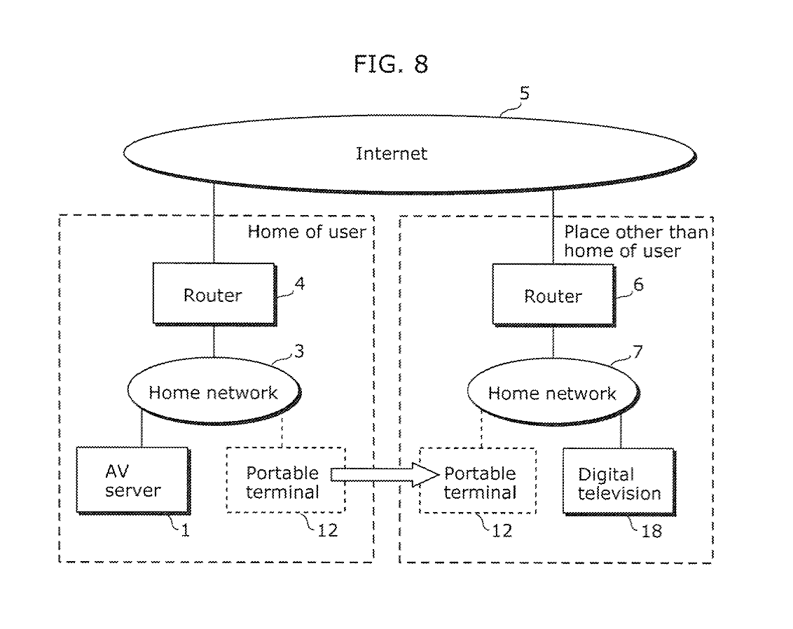

FIG. 8 is a diagram showing the data transmission and reception system according to this Embodiment in which the data transmission apparatus, a data reception apparatus, and the router are connected via the home network and the Internet.

FIG. 8 shows the home of the user in which the AV server 1 and the router 4, which are the data transmission apparatuses, are connected via the home network 3.

The router 4 is also connected to the router 6 installed in the place other than the home of the user via the Internet 5. The router 6 is connected to a digital television 18, which is the data reception apparatus, via the home network 7.

A portable terminal 12, which is the data transmission and reception control apparatus, is the apparatus which is carried around and used by the user. When the user is at home, the portable terminal 12 is connected to the home network 3 established in the home of the user to communicate with the apparatus installed in the home of the user; and when the user is in the place other than the home of the user, the portable terminal 12 is connected to the home network 7 to communicate with the apparatus installed in the place other than the home of the user.

The data transmission and reception system according to Embodiment 2 is different from the data transmission and reception system according to Embodiment 1 in that a structure and a function of the portable terminal 12, which is the data transmission and reception control apparatus, and the digital television 18, which is the data reception apparatus, are different from the structure and the function of the portable terminal 2 and the digital television 8 according to Embodiment 1. The other structures are the same. The following describes the structure of the portable terminal 12, which is the data transmission and reception control apparatus, and the digital television 18, which is the data reception apparatus.

<Structure of the Data Transmission and Reception Control Apparatus>

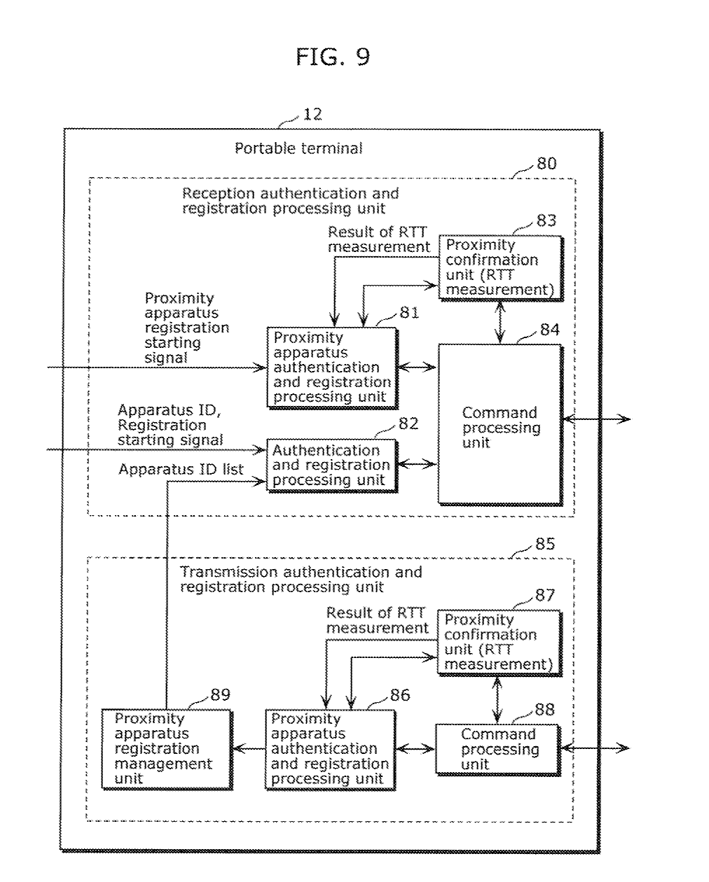

FIG. 9 is a block diagram showing a structure of an authentication and registration processing unit in the portable terminal 12, which is the data transmission and reception control apparatus, according to this Embodiment.

The authentication and registration processing unit in the portable terminal 12 includes: a reception authentication and registration processing unit 80 which performs the authentication and registration processing as the data reception apparatus for the data transmission apparatus (for example, the AV server 1 in FIG. 8); and the transmission authentication and registration processing unit 85 which performs the authentication and registration processing as the data transmission apparatus for the data reception apparatus (for example, the digital television 18 in FIG. 8).

The reception authentication and registration processing unit 80 includes: a proximity apparatus authentication and registration processing unit 81, an authentication and registration processing unit 82, a proximity confirmation unit 83, and a command processing unit 84. The transmission authentication and registration processing unit 85 includes: a proximity apparatus authentication and registration processing unit 86, a proximity confirmation unit 87, and a command processing unit 88, and a proximity apparatus registration management unit 89.

In this Embodiment, the proximity apparatus authentication and registration processing unit 86 includes the functions of the registration starting and authentication processing unit.

When receiving the proximity apparatus registration starting signal, the proximity apparatus authentication and registration processing unit 81 in the reception authentication and registration processing unit 80 performs the following in conjunction with the data transmission apparatus by controlling the proximity confirmation unit 83 and the command processing unit 84: the proximity apparatus registration and authentication processing in which the apparatus ID of the data transmission and reception control apparatus is registered into the data transmission apparatus after performing the mutual authentication; and the RTT measurement processing in which the proximity is confirmed.

The authentication and registration processing unit 82, for example when the apparatus to be registered is selected by the user through the operation of the portable terminal 12, receives the apparatus ID to be registered and the registration starting signal. Furthermore, when receiving the registered apparatus ID list from the proximity apparatus registration management unit 89, the authentication and registration processing unit 82 performs authentication and registration processing in conjunction with the data transmission apparatus by controlling the command processing unit 84.

The proximity confirmation unit 83 measures the RTT to the data transmission apparatus by controlling the command processing unit 84, and then outputs the result of the RTT measurement to the proximity apparatus authentication and registration processing unit 81.

Under the control of the proximity apparatus authentication and registration processing unit 81, the authentication and registration processing unit 82, and the proximity confirmation unit 83, the command processing unit 84 performs the transmission and reception of various commands between the command processing unit 84 and the data transmission apparatus.

The proximity apparatus authentication and registration processing unit 86 in the transmission authentication and registration processing unit 85, using the command processing unit 88, performs the proximity apparatus authentication and registration processing in conjunction with the data reception apparatus, and outputs, to the proximity apparatus registration management unit 89, the apparatus ID of the data reception apparatus depending on the result of the RTT measurement received from the proximity confirmation unit 87.

The proximity confirmation unit 87 performs, by controlling the command processing unit 88, the RTT measurement processing in conjunction with the data reception apparatus to measure the RTT to the data reception apparatus, and confirms the proximity by comparing the measured RTT with a predetermined value (in this Embodiment, 1 ms), and then outputs, to the proximity apparatus authentication and registration processing unit 86, the confirmed proximity as the result of the RTT measurement. The proximity confirmation unit 87 also transmits to the data reception apparatus the result of the RTT measurement using the command processing unit 88.

Under the control of the proximity apparatus authentication and registration processing unit 86 and the proximity confirmation unit 87, the command processing unit 88 performs the transmission and reception of various commands between the command processing unit 88 and the data reception apparatus.

The proximity apparatus registration management unit 89 receives the apparatus ID from the proximity apparatus authentication and registration processing unit 86, and registers and manages the received apparatus ID, and transmits the registered and managed apparatus ID to the authentication and registration processing unit 82 as the registered apparatus ID list.

<A Structure of the Data Reception Apparatus>

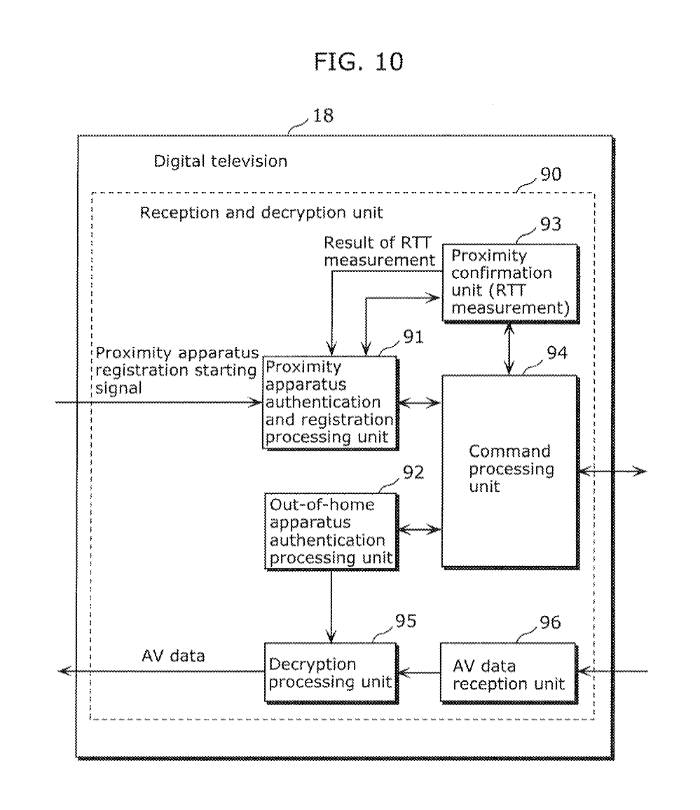

FIG. 10 is a block diagram showing a structure of a reception and decryption unit 90 in the digital television 18, which is the data reception system.

The reception and decryption unit 90 in the digital television 18 includes: the proximity apparatus authentication and registration processing unit 91, the out-of-home apparatus authentication processing unit 92, the proximity confirmation unit 93, the command processing unit 94, the decryption processing unit 95, and the AV data reception unit 96.

When the proximity apparatus authentication and registration processing unit 91 receives the proximity apparatus registration starting signal, for example when the user specifies the apparatus to be registered through the operation of the portable terminal 12, the proximity apparatus authentication and registration processing unit 91 performs, by controlling the proximity confirmation unit 93 and the command processing unit 94, the proximity apparatus authentication and registration processing and the RTT measurement processing in conjunction with the portable terminal 12.

The out-of-home apparatus authentication processing unit 92, using the command processing unit 94, performs the out-of-home apparatus authentication processing and the key exchange processing in conjunction with the AV server 1, which is the data reception apparatus, and outputs the decryption key to the decryption processing unit 95.

The proximity confirmation unit 93, using the command processing unit 94, performs the RTT measurement processing in conjunction with the portable terminal 12, and then outputs the result of the RTT measurement to the proximity apparatus authentication and registration processing unit 91.

Under the control of the proximity apparatus authentication and registration processing unit 91, the proximity confirmation unit 93, and the out-of-home apparatus authentication processing unit 92, the command processing unit 94 performs the transmission and reception of various commands either between the command processing unit 94 and the portable terminal 12 or between the command processing unit 94 and the AV server 1 via the home network 7.

The decryption processing unit 95 decrypts, using the decryption key received from the out-of-home apparatus authentication processing unit 92, the encrypted AV data received from the AV data reception unit 96 and then outputs the decrypted AV data.

The AV data reception unit 96 receives the encrypted AV data via the home network 7, and outputs the encrypted AV data to the decryption processing unit 95.

Following describes a sequence of each processing performed by the data transmission and reception system which includes the apparatuses described above.

<A Sequence of Proximity Apparatus Registration Processing>

The proximity apparatus registration processing performed by the data transmission and reception system according to this Embodiment is the same as the processing sequence of the proximity apparatus registration processing shown in FIG. 5 in Embodiment 1.

<A Sequence of Registration Processing>

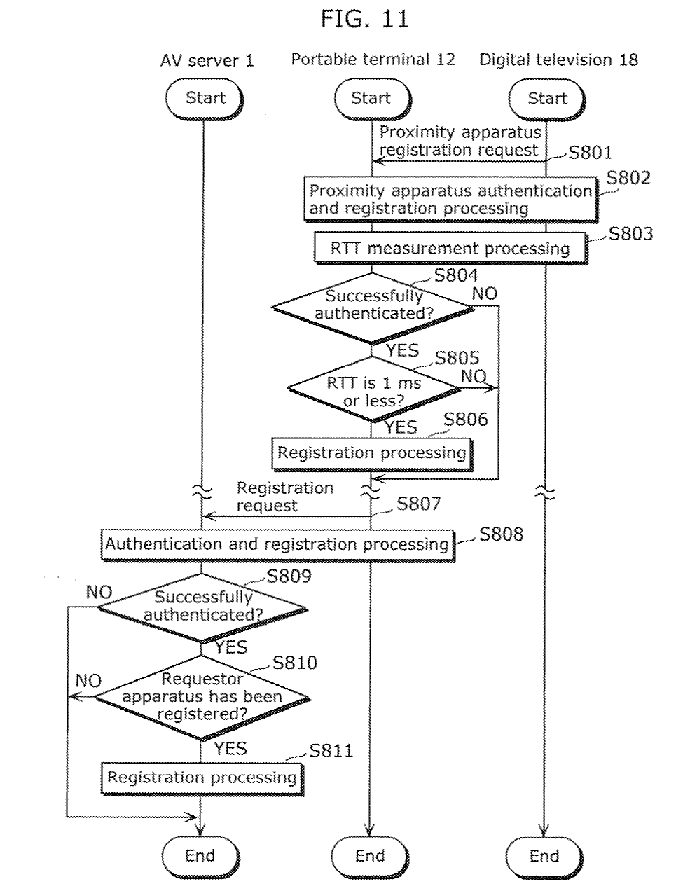

FIG. 11 is a diagram showing a processing sequence of the registration processing in which, through the portable terminal 12, which is the data transmission and reception control apparatus, the apparatus ID of the digital television 18, which is the data reception apparatus installed in the place other than the home of the user, is registered into the AV server 1, which is the data output apparatus installed in the home of the user, as the apparatus which has permission to access the AV server 1 from out-of-home.

After performing the proximity apparatus registration processing described above, in the place other than the home of the user, the portable terminal 12 receives from the digital television 18, which is the data reception apparatus, the proximity apparatus registration request along with the apparatus ID of the digital television 18 (S801), and performs the proximity apparatus authentication and registration processing S802 and subsequently performs the RTT measurement processing S803. The portable terminal 12 determines in the determination processing S804 whether or not the digital television 18 has been successfully authenticated, and confirms in the determination processing S805 whether or not the RTT is 1 ms or less in order to confirm the proximity. When it is YES in both steps S804 and S805, the proximity apparatus registration management unit 89 holds the apparatus ID of the digital television 18 (S806).

At this point, further processing of registration of the apparatus ID of the digital television 18 into the AV server 1 is suspended, and the portable terminal 12 goes into a standby state waiting for the operation by the user.

The above description mentioned that the registration processing is performed after performing the proximity apparatus registration processing though, it is to be noted that the order of the proximity apparatus registration processing and the registration processing may vary. The proximity apparatus registration processing may be performed while the registration processing into the AV server 1 is suspended. The proximity apparatus registration processing needs to be performed prior to the performance of a registration request processing S807. Then, in the remaining parts of the processing of registration into the AV server 1, the portable terminal 12 can register the apparatus ID of the digital television 18 into the AV server 1.

Subsequently, when the user operates the portable terminal 12 to select the apparatus ID to be registered and when the remaining parts of the processing of registration into the AV server 1 is started, the portable terminal 12 transmits, to the AV server 1 installed in the home of the user, the registration request along with the apparatus ID of the digital television 18 and the apparatus ID of itself, the portable terminal 12 as the requestor, via the Internet 5 (S807), and performs the authentication and registration processing S808 which does not involve the RTT measurement. The AV server 1 determines in the determination processing S809 whether or not the digital television 18 has been successfully authenticated, and confirms in the determination processing S810 whether or not the apparatus ID of the portable terminal 12, which is the registration requestor, has been registered in the proximity apparatus registration management unit 33. When it is YES in both steps S809 and S810, the AV server 1 registers the apparatus ID of the digital television 18 received from the portable terminal 12 in the proximity apparatus registration management unit 33 as the apparatus which has permission to access the AV server 1 from out-of-home (S811).

<A Sequence of an Encrypted-Data Transmission Processing>

The encrypted-data transmission processing performed by the data transmission and reception system according to this Embodiment is the same as the processing sequence of the encrypted-data transmission processing shown in FIG. 7 of Embodiment 1.

With the processing described above, the data transmission and reception system according to this Embodiment allows the data reception apparatus installed in the place other than the home of the user to access the data transmission apparatus installed in the home of the user and receive the AV data via the Internet, in the same manner as the data transmission and reception system according to Embodiment 1. In addition, with the data transmission and reception system according to this Embodiment, it is possible to prevent the unrestricted distribution of AV data stored in the data transmission apparatus installed in the home to the out-of-home data reception apparatus.

Further, the data transmission and reception control apparatus according to this Embodiment can register, as the data transmission apparatus, the proximity apparatus. The data transmission and reception control apparatus according to this Embodiment is used to confirm the proximity to the data reception apparatus, and to obtain the apparatus ID of the data reception apparatus. Thus, it is unnecessary to provide the special function for starting the registration, the structure of the data transmission and reception control apparatus can be simplified. In addition, the data transmission and reception control apparatus according to this Embodiment registers and manages the apparatus ID of the data reception apparatus obtained. This allows the obtainment of the apparatus ID from the data reception apparatus and the registration of the obtained apparatus ID into the data transmission apparatus to be performed at different times. It is unnecessary to go back the processing to the obtainment of apparatus ID of the data reception apparatus even in the case where the registration processing fails. Furthermore, the apparatus ID registered and managed can be registered into more than one data transmission apparatus.

It is to be noted that although the proximity is confirmed through the RTT measurement in each Embodiment of the present invention, other methods may also be used. For example, a physical proximity can be confirmed by measuring a distance to the reception apparatus; proximity on a network can be confirmed by checking whether or not the reception apparatus is on the same subnet; or it may be confirmed whether or not wire communication is performed with the reception apparatus.

It is to be noted that although the data transmission and reception control apparatus in each Embodiment of the present invention includes only a registration function of the identification information of the apparatus, the data transmission and reception control apparatus may include a function for the out-of-home apparatus authentication so that the data transmission and reception control apparatus itself can also access, from out-of-home, the data transmission apparatus installed in the home of the user.

Also, in proximity apparatus registration management in each Embodiment of the present invention, a maximum number for registering the apparatuses may be set so that the AV data distribution to out-of-home apparatus is limited by the maximum number of apparatuses which are likely to be used by the user within the realm of personal use.

In addition, although the data transmission and reception control apparatus used in each Embodiment of the present invention is of a portable type, it is obvious that the apparatus does not necessarily have to be portable, but any data transmission and reception control apparatus may be used as long as the data transmission and reception control apparatus is movable.

### INDUSTRIAL APPLICABILITY

The present invention can be used as a data transmission and reception system which performs transmission and reception of AV data while protecting a copyright.

### REFERENCE SIGNS LIST

1, 101 AV server
2, 12, 106 Portable terminal
3, 7, 103 Home network
4, 6 Router
5, 105 Internet
8, 18, 102 Digital television
20, 80 Reception authentication and registration processing unit
21, 31, 81, 86, 91 Proximity apparatus authentication and registration processing unit
22, 32, 82 Authentication and registration processing unit
23, 27, 34, 43, 83, 87, 93 Proximity confirmation unit
24, 28, 35, 44, 84, 88, 94 Command processing unit
25, 85 Transmission authentication and registration processing unit
26, 41 Registration starting and authentication processing unit
30 Encryption and transmission unit
33, 89 Proximity apparatus registration management unit
36, 42, 92 Out-of-home apparatus authentication processing unit
37 Encryption processing unit
38 AV data transmission unit
40, 90 Reception and decryption unit
45, 95 Decryption processing unit
46, 96 AV data reception unit
104 Home boundary bridge
107 Portable PC

1. A data transmission and reception control apparatus comprising:
a first proximity confirmation unit configured to confirm whether or not a first proximity condition is satisfied, the first proximity condition relating to a distance on a network between a data transmission apparatus which transmits AV data to a pre-registered apparatus and said data transmission and reception control apparatus;
a proximity apparatus authentication and registration processing unit configured to perform authentication in conjunction with the data transmission apparatus, and, when the authentication is successful and when it is confirmed that the first proximity condition is satisfied, to register first identification information into the data transmission apparatus, the first identification information being identification information of said data transmission and reception control apparatus;
a second proximity confirmation unit configured to confirm whether or not a second proximity condition is satisfied, the second proximity condition relating to a distance on a network between a data reception apparatus which is capable of receiving the AV data and said data transmission and reception control apparatus;
a registration starting and authentication processing unit configured to perform authentication in conjunction with the data reception apparatus, and, when the authentication is successful and when it is confirmed that the second proximity condition is satisfied, to obtain second identification information that is the identification information of the data reception apparatus; and
an authentication and registration processing unit configured to perform authentication in conjunction with the data transmission apparatus, and, when the authentication is successful, to register the obtained second identification information into the data transmission apparatus.

2. The data transmission and reception control apparatus according to claim 1, further comprising
a proximity apparatus registration management unit configured to hold the obtained second identification information,
wherein said authentication and registration processing unit is configured to register the second identification information into the data transmission apparatus, the second identification information being held in said proximity apparatus registration management unit.

3. The data transmission and reception control apparatus according to claim 1,
wherein said first proximity confirmation unit is configured to measure a round trip time of a predetermined packet sent to the data transmission apparatus, and to confirm as the first proximity condition that the measured round trip time is less than a predetermined reference time, and
said second proximity confirmation unit is configured to measure the round trip time of a predetermined packet sent to the data reception apparatus, and to confirm as the second proximity condition that the measured round trip time is less than a predetermined reference time.

4. A system for data transmission and reception, said system comprising a data transmission apparatus which transmits AV data to a pre-registered apparatus, a data reception apparatus which is capable of receiving the AV data, and the data transmission and reception control apparatus according to claim 1,
wherein, when the authentication in conjunction with said data transmission and reception control apparatus is successful and when the identification information of said data transmission and reception control apparatus has been registered in said data transmission apparatus, said data transmission apparatus transmits to said data reception apparatus the AV data according to the registration of the identification information of said data reception apparatus into said data transmission apparatus by said data transmission and reception control apparatus.

5. A method for controlling data transmission and reception performed by a data transmission and reception control apparatus, said method comprising:
confirming whether or not a first proximity condition is satisfied, the first proximity condition relating to a distance on a network between a data transmission apparatus which transmits AV data to a pre-registered apparatus and the data transmission and reception control apparatus;
performing authentication in conjunction with the data transmission apparatus, and, when the authentication is successful and when it is confirmed that the first proximity condition is satisfied, registering first identification information into the data transmission apparatus, the first identification information being identification information of the data transmission and reception control apparatus;
confirming whether or not a second proximity condition is satisfied, the second proximity condition relating to a distance on a network between a data reception apparatus which is capable of receiving the AV data and the data transmission and reception control apparatus;
performing authentication in conjunction with the data reception apparatus, and, when the authentication is successful and when it is confirmed that the second proximity condition is satisfied, obtaining second identification information, the second identification information being the identification information of the data reception apparatus; and
performing authentication in conjunction with the data transmission apparatus, and, when the authentication is successful and when the identification information of the data transmission and reception control apparatus has been registered in the data transmission apparatus, registering the obtained second identification information into the data transmission apparatus.

6. A computer executable program for controlling transmission and reception of data, said program causing a computer to execute the steps included in the data transmission and reception control method according to claim 5.
